(19) United States
(12) Patent Application Publication
(10) Pub. No.: US 2013/0201730 A1
(43) Pub. Date: Aug. 8, 2013

(54) Alternating Parallel Fly Back Converter with Alternated Master-Slave Branch Circuits

(71) Applicant: Yuhao Luo, Jiaxing (CN)

(72) Inventor: Yuhao Luo, Jiaxing (CN)

(73) Assignee: ALTENERGY POWER SYSTEM, INC., (CN)

(21) Appl. No.: 13/807,053

(22) PCT Filed: Jun. 29, 2011
(86) PCT No.: PCT/CN11/76541

§ 371 Date: Apr. 22, 2013

(30) Foreign Application Priority Data
Jul. 1, 2010 (CN) 201010217523.3

(51) Int. Cl. H02M 3/335

(52) U.S. Cl. CPC H02M 3/33507
USPC 363/21.17

(57) ABSTRACT

An alternating parallel flyback converter with alternated master and slave circuit branches is provided. The flyback converter includes a master flyback circuit branch, a slave flyback circuit branch connected with the master flyback circuit branch in parallel, and a controller. The controller controls the operation of each of the flyback circuit branches based on the current and the voltage at the output terminal of the flyback converter. The master flyback circuit branch operates continuously while the slave flyback circuit branch only operates when the output power of the flyback converter is higher than a threshold. The master flyback circuit branch and the slave flyback circuit branch are periodically alternated, and in particular, through zero crossing of the power. With the flyback converter of the present invention, the reliability and the service life of the converter can be improved.

### CROSS REFERENCE TO RELATED APPLICATIONS

This application is a National Phase application filed under 35 U.S.C. §371 of International Application No. PCT/CN2011/076541, filed Jun. 29, 2011, which claims benefit of and the priority to Chinese Patent Application No. CN 201010217523.3, filed Jul. 1, 2010, which applications are hereby incorporated by reference in their entirety.

### TECHNICAL FIELD

The invention relates to an energy conversion device, particularly, an energy conversion device of flyback converter.

### BACKGROUND OF THE INVENTION

A flyback conversion topology is a commonly used DC-DC conversion technology, and can be used in the condition where the electrical insulation, boosting and high efficiency are required. The flyback topology comprises a transformer, a switching device, and a diode. Normally, the switching device can be connected in series with the primary coil of the transformer, and the secondary coil of the transformer can be connected to the load via a series diode. The direct current voltage can be boosted by switching on and off the current in the primary coil.

In order to double the output power, two flyback converters connected in parallel can be used to operate alternately. Each flyback converter forms a branch circuit, and operates independently and alternately. Two branch circuits should be matched to ensure balanced operation such that the energy conversion can be performed efficiently. However, all of the devices may consume more energy when two branch circuits operate simultaneously, whereby the efficiency may be decreased. One method for reducing the energy consumption is to use master-slave branch circuits, where the master branch circuit operates continuously, and the slave branch circuit stops to operate when the power is low.

However, when the master branch circuit and the slave branch circuit are fixed, a mismatch between them and related problems (such as the temperature difference, aging of different devices, and the like) may be caused by different operation states between them. In addition, the master branch circuit is a factor for limiting the reliability and service life of the converter because it operates more than the slave branch circuit.

### BRIEF SUMMARY OF THE INVENTION

The object of the invention is to solve the above problems and to provide an alternating parallel flyback converter with alternated master-slave branch circuits for increasing the reliability and the service life of the converter.

The technical scheme of the invention is: The invention discloses an alternating parallel flyback converter with alternated master-slave branch circuits, which comprises:

a plurality of flyback circuits connected in parallel;

an output current detector for detecting the current at the output terminal of said alternating parallel flyback converter;

an output voltage detector for detecting the voltage at the output terminal of said alternating parallel flyback converter;

a controller, coupled to said output current detector and said output voltage detector, and coupled to the switches of each of the flyback circuits, respectively, for controlling the operation of each flyback circuit based on the detected current and voltage; a portion of the flyback circuits being set as the master branch circuits, and the remaining portion of the flyback circuits being set as the slave branch circuits, wherein said master branch circuit operates continuously under the control of said controller, and said slave branch circuit only operates when the power at the output terminal of said alternating parallel flyback converter is higher than the threshold, and wherein the operation of the master branch circuit and the slave branch circuit can be alternated periodically under the control of said controller.

According to an embodiment of the alternating parallel flyback converter with alternated master-slave branch circuits of the invention, said each flyback circuit further comprises:

a transformer;

a switching device connected in series to the primary coil of said transformer; and

a diode connected in series to said secondary coil of the transformer.

According to an embodiment of the alternating parallel flyback converter with alternated master-slave branch circuits of the invention, said switching device is a field effect transistor.

According to an embodiment of the alternating parallel flyback converter with alternated master-slave branch circuits of the invention, said controller further comprises:

a detection circuit, its input terminal is coupled to said output current detector and said output voltage detector, for converting the output current and output voltage in the form of the analog signals to the digital signals;

a processing circuit coupling to said detection circuit, the control signal of each flyback circuit can be obtained and transmitted by using the zero crossing of the power based on the output current and output voltage in the form of digital signal; and

a control circuit coupling to said processing circuit, an operation signal for switching on or off the switching device in said each connected flyback circuit can be issued based on the received control signal.

According to an embodiment of the alternating parallel flyback converter with alternated master-slave branch circuits of the invention, the periodical alternation between the master branch circuit and the slave branch circuit can be controlled by said controller through the zero crossing of the power.

According to an embodiment of the alternating parallel flyback converter with alternated master-slave branch circuits of the invention, said alternating parallel flyback converter is a direct current to direct current converter.

According to an embodiment of the alternating parallel flyback converter with alternated master-slave branch circuits of the invention, said direct current to direct current converter further comprises:

an input capacitor connecting to the input terminal of said converter, for storing the energy.

Compared with the prior art, the invention has the following benefits: By setting the flyback converter having the master and the slave flyback circuits in the invention, the operation of each flyback circuit can be controlled by the current and voltage at the output terminal; the master branch circuit operates continuously, and the slave branch circuit only operates when the power is higher than the threshold, while the master branch circuit and the slave branch circuit can be alternated periodically, and particularly, the periodical alternation between the maser-slave branch circuits can be performed through the zero crossing of the power.

### BRIEF DESCRIPTION OF THE DRAWINGS

FIG. 1 is a schematic diagram of an embodiment of the alternating parallel flyback converter with alternated master-slave branch circuits of the invention.

FIG. 2 illustrates the principle of operation of a controller in the embodiment shown in FIG. 1.

FIG. 3 is a signal timing diagram when an alternating flyback DC-DC converter in the prior art is used.

FIG. 4 is a signal timing diagram when an alternating parallel flyback converter without alternation means is used.

FIG. 5 is a signal timing diagram of the present invention when an alternating parallel flyback converter with alternation means is used.

### DETAILED DESCRIPTION OF THE INVENTION

The invention will be further described by using the drawings and the embodiments.

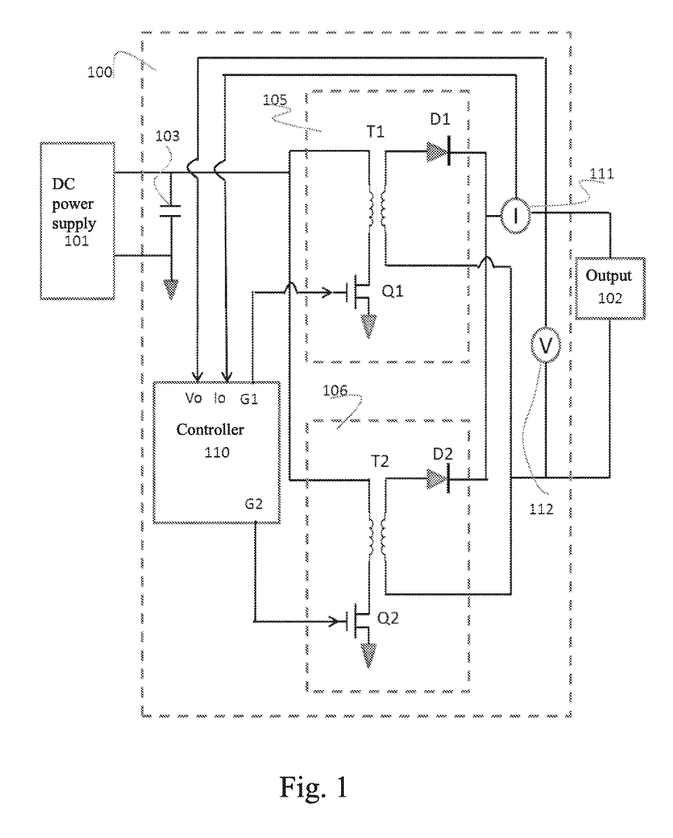

FIG. 1 shows a structure diagram of an embodiment of the alternating parallel flyback converter with alternated master-slave branch circuits of the invention. Referring to FIG. 1, for purpose of illustration, an example of two flyback circuits connected alternately in parallel are described in the embodiment, wherein one branch is defined as the master branch circuit, and the other branch is defined as the slave branch circuit, and wherein the embodiment is also a direct current to direct current (DC-DC) converter 100. The direct voltage of a direct power supply 101 is converted by the DC-DC converter 100 to a direct voltage output 102. The direct power supply 101 can be a photovoltaic DC power supply or a DC power supply of other source. The direct voltage output 102 can be connected to a device, which uses the DC power supply, including a direct current to alternating current (DC-AC) converter.

The DC-DC converter 100 comprises an input capacitor 103 connecting to the direct power supply 101 for storing the energy. Two flyback circuits 105 and 106 are connected in parallel with respect to the direct power supply 101 at the input terminal and the direct voltage output 102 at the output terminal, where the structures of two flyback circuits are the same, and they are called “branch circuits” in the embodiment. The flyback circuit 105 comprises a transformer T1, a switch Q1 and two diodes D1s, the primary coil of the transformer T1 being connected in series to the switch Q1, the secondary coil of the transformer T1 being connected to the direct voltage output 102 via the diodes D1s. Similarly, the flyback circuit 106 comprises a transformer T2, a switch Q2 and two diodes D2s, the primary coil of the transformer T2 being connected in series to the switch Q2, the secondary coil of the transformer T2 being connected to the direct voltage output 102 via the diodes D2s.

In the embodiment, the switch Q1 is a field effect transistor (FET). The drain of the field effect transistor is coupled to the ground, the source is coupled to the primary coil of the transformer T1, and the gate is coupled to the G1 output port of the controller 110. Similarly, the switch Q2 is also a field effect transistor. The drain of the field effect transistor is coupled to the ground, the source is coupled to the primary coil of the transformer T2, and the gate is coupled to the G2 output port of the controller 110.

An output current detector 111 and an output voltage detector 112 are also disposed at the direct voltage output 102 of the output terminal. The output current detector 111 is coupled to the lo port of the controller 110, and the output voltage detector 112 is coupled to the Vo port of the controller 110, both of which are used for controlling to switch on or off the branch circuits (that is, the flyback circuits 105 or 106), so that the alternating control of the master-slave branch circuits can be implemented.

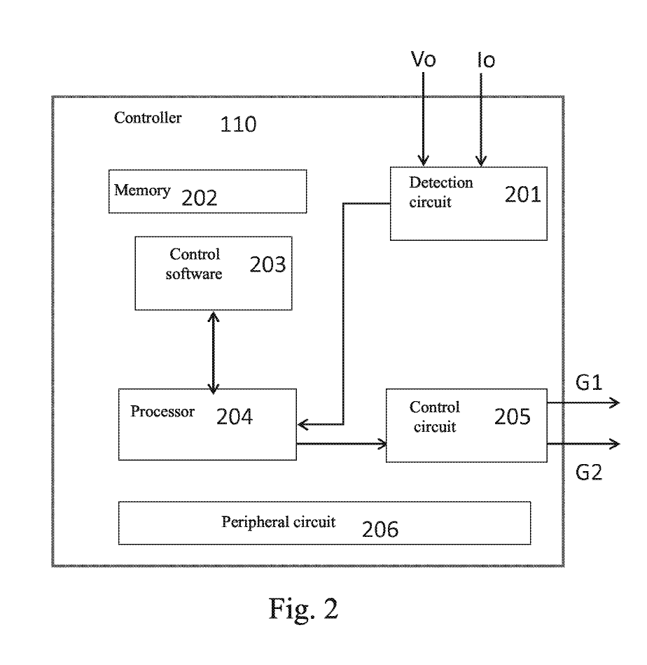

FIG. 2 shows an internal principle of operation of the controller 110. Referring to FIG. 2, the controller 110 of the embodiment comprises a detection circuit 201, a memory 202, a processor 204, a control circuit 205, and a peripheral circuit 206. The current signal extracted from the output current detector 111 and the voltage signal extracted from the output voltage detector 112 are converted from analog signals to digital signals by using an analog to digital converter in the detection circuit 201. The memory 202 can be any type of memory component, such as random access memory, read only memory, flash memory chip, processor register, cache, hard disk, readable or writable CD-ROM or tape storage, capacitor, other circuit, or known device of any other type. A control software 203 stored in the memory 202 can be executed by the processor 204. The control signals of each of the branch circuits (the flyback circuits 105 or 106) can be extracted by the processor 204 based on the output current and output voltage in the digital signal form, which are transmitted to the control circuit 205. During such processing, one of the flyback circuit can be set as a master branch circuit and the other flyback circuit can be set as a slave branch circuit, and the master branch circuit operates continuously while the slave branch circuit only operates when the power is higher than the threshold; in addition, the master-slave branch circuits can also be controlled alternately (for example, the master branch circuit and the slave branch circuit can be swapped periodically), which will be described in detail hereunder. The operation signal for switching on or off the switching devices Q1 or Q2 of the connected flyback circuits can be delivered by the control circuit 205 based on the received control signal. The processor 204 can be in the form of a processor, a micro-controller, an FGPA, or an Application Specific Integrated Circuit (ASIC). The peripheral circuit 209 can comprise known peripheral circuit, for example, power supply, clock circuit, bus circuit, I/O of the circuit, and the like.

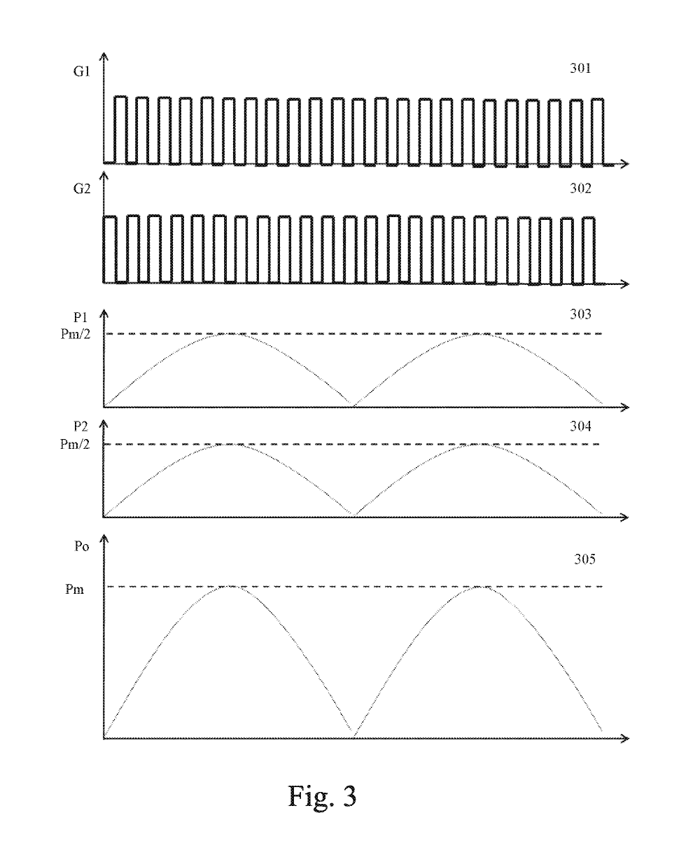

FIG. 3 is a signal timing diagram of an alternating flyback converter circuit of the prior art. The object described by a coordinate 301 is a signal at G1 port of the controller 110, i.e., the gate circuit of the switch Q1; the object described by a coordinate 302 is a signal at G2 port of the controller 110, i.e., the gate circuit of the switch Q2. It can be seen from the coordinate 301 and coordinate 302, that each branch circuit (the flyback circuits 105, 106) can be excited or stopped by the DC-DC converter 100. Each branch circuit operates alternately, such that one branch circuit is excited while another branch circuit is stopped, and vice versa. An envelope P1 of the output power of the flyback circuit 105 is shown by the coordinate 303, and an envelope P2 of the output power of the flyback circuit 106 is shown by the coordinate 304. In the prior art, the coordinate 303 and coordinate 304 are the same, and the coordinate 305 indicates a composite power consumption Po which is the sum of the output power P1 and the output power P2, and indeed also equals the product of the output current Io detected by the output current detector 111 and the output voltage Vo detected by the output voltage detector 112. The peak value of the composite power consumption Po is Pm, and each of the peak values of P1 and P2 is Pm/2. Thus, in the alternating method, the ripple of the DC current and voltage can be reduced; furthermore, by using the flyback circuits connected in parallel, there is a load which increases significantly the output power, where for example, the output power of two circuits connected in parallel can be doubled. It can be seen that two branch circuits are not divided into the master circuit and the slave circuit in the prior art.

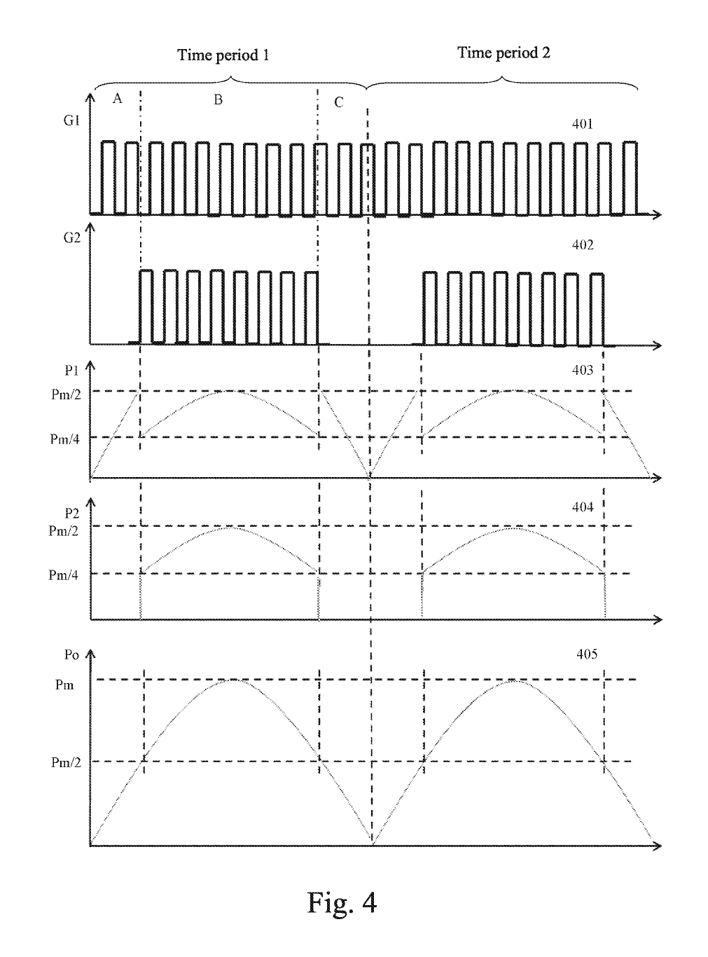

A slight improvement in one embodiment is to divide two circuits into the master branch circuit and the slave branch circuit, wherein the master branch circuit operates continuously, and the slave branch circuit stops when the power of the DC voltage output 102 at the output terminal is lower than the threshold. FIG. 4 is a signal timing diagram of such alternating parallel flyback converter with alternated master-slave branch circuits. The gate voltages G1 and G2 of the switches Q1 and Q2 are described by the coordinates 401 and 402, respectively, the envelope P1 of the output power of the flyback circuit (branch circuit) 105 is shown by the coordinate 403, and the envelope P2 of the output power of the flyback circuit (branch circuit) 106 is shown by the coordinate 404. A composite power consumption is shown by the coordinate 405, i.e., the sum of P1 and P2. Even though the coordinates 405 and 305 are the same, the coordinates 403 and 303 as well as the coordinates 404 and 303 are different. All of the time periods are the same, as shown by period 1 and period 2, and there are three regions of A, B, and C in each period. In region A, Po increases from 0 up to Pm/2; in region B, Po increases from Pm/2 up to Pm, then decreases to Pm/2; in region C, Po decreases from Pm/2 to 0. In region A and region C, only the master branch circuit operates while the slave branch circuit stops; P2 is 0, and P1 is between 0 and Pm/2, rather than Pm/4 as shown by the coordinate 303. In region B, the master branch circuit and the slave branch circuit operate evenly, P1 and P2 are the same, which is the same as shown by the coordinate system 303 and 304.

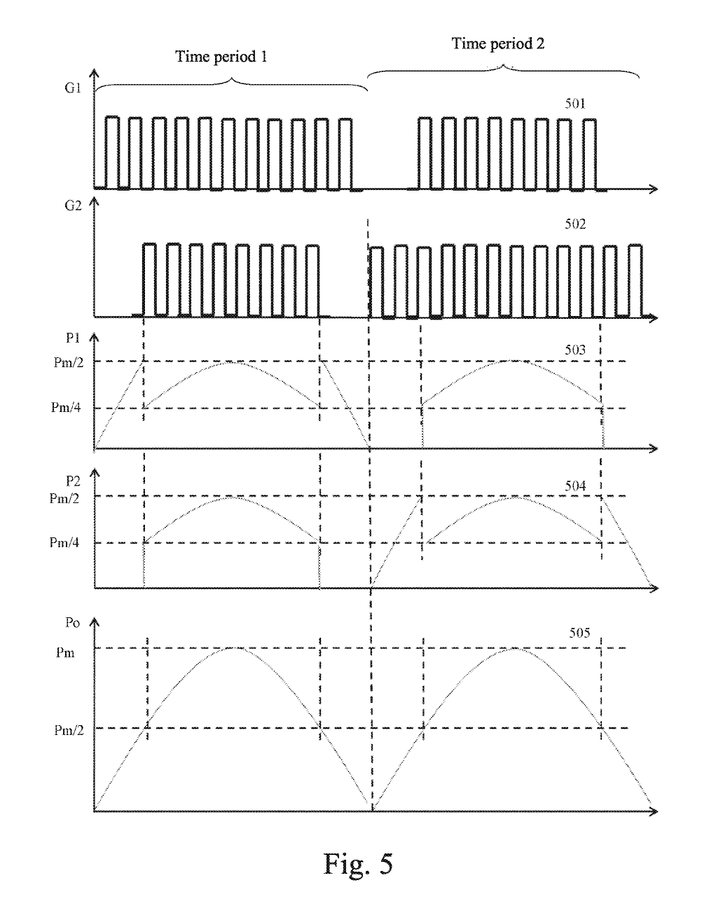

The alternation between the master branch circuit and the slave branch circuit will now be described in detail as follows. When the master branch circuit is a fixed branch circuit, the master branch circuit operates continuously, and sometimes the slave branch circuit do not operate, so that two branch circuits are mismatched, for example, in the temperature and stress aspects, and the like, which causes all of the problems related to mismatch. Furthermore, because the master branch circuit bears more stress, it limits the service life of the converter. Thus, the alternation between the master branch circuit and the slave branch circuit can be controlled by the controller 110 in the embodiment; that is, the master branch circuit and the slave branch circuit are alternated periodically so that the operation time periods of two branch circuits are the same, and are less than that in the fixed master branch circuit condition. Referring to FIG. 5, the gate voltage signal G1 and G2 of the switches Q1 and Q2 are described by the coordinates 501 and 502. In time period 1, the branch circuit 105 is a master branch circuit, while the branch circuit 106 is a slave branch circuit. As indicated above, the branch circuit 105 operates continuously, while the branch circuit 106 does not operate when the power is lower than the threshold. In the time period 2, the branch circuit 106 is a master branch circuit, while the branch circuit 105 is a slave branch circuit. The envelope P1 of the output power of the branch circuit 105 is shown by the coordinate 503, the envelope P2 of the output power of the branch circuit 106 is shown by the coordinate 504, and the composite power consumption Po which is the sum of P1 and P2, is shown by the coordinate 505. In the time period 1, the coordinates 503 and 403 are the same, and the coordinates 504 and 404 are the same. However, in the time period 2, the master-slave branch circuits alternate, the coordinates 503 and 404 are the same, and the coordinates 504 and 403 are the same. The specific triggering point of the alternation can be controlled by the zero crossing of the composite power consumption Po; that is, when Po reaches 0, the master branch circuit changes to a slave branch circuit, and the slave branch circuit changes to a master branch circuit.

In the above example, the alternation period is an output power period. Of course, any alternation period can be set by the controller 110, for example, multi-periods, one second, one minute, one hour, one day, one week, one month, or other period.

It should be understood, while an example of two branch circuits is shown in the above embodiment, any number (N) of branch circuits can be expanded to in the invention. For the peak output power Pm of Po, the peak output power of each branch circuit is Pm/N. The threshold voltage for controlling the alternation can be set as Pth=Pm/(N*N). The number of the operating branch circuits is an integer quotient of Po to Pth. When Po is between 0 and Pth, one branch circuit operates and is called a master branch circuit. When Po is between Pth and 2Pth, two branch circuits operate, one being master branch circuit, and the other being slave branch circuit. When Po is between i*Pth and i*(i+1)*Pth, the master branch circuit and the first to the i slave branch circuit operate. When Po is between (n−1)*Pth and Pm, all of the branch circuits operate, including the master branch circuit and the first to the N−1 slave branch circuits. Similarly as in the above example, the master branch circuit and the slave branch circuits are alternated; for example, the master branch circuit changes to the slave branch circuit 1, the slave branch circuit 1 changes to the slave branch circuit 2, the slave branch circuit N−1 changes to the master branch circuit.

Another aspect to be understood is that the branch circuit in the above embodiment is controlled by the output power Po, and if the output voltage Vo is a constant DC voltage, then the output current Io can also be used to control the branch circuit.

A plurality of flyback circuits connected in parallel are disposed in the flyback converter of the invention, wherein by controlling the operation of the respective flyback circuits via the controller, a portion of the flyback circuits are set as the master branch circuit, and another portion of the flyback circuits are set as the slave branch circuits, wherein the master branch circuit operates continuously, while the slave branch circuit only operates when the power is higher than the threshold. In addition, the periodical alternation between the master branch circuit and the slave branch circuits can be controlled by the controller. Compared with the prior art, the operation time of a single branch circuit can be reduced in the present invention, and the reliability and the service life of the converter can be increased.

The above embodiment is provided for those skilled in the art to implement or use the invention, and various modifications or changes can be made by those skilled in the art without departing from the inventive idea of the invention. Thus, the protection scope of the invention is not limited by the above embodiments; rather, it conforms to the largest scope of the inventive features mentioned in the Claims.

1. An alternating parallel flyback converter with alternated master-slave branch circuits, comprising:
a plurality of flyback circuits connected in parallel;
an output current detector for detecting an output current at an output terminal of said alternating parallel flyback converter;
an output voltage detector for detecting an output voltage at an output terminal of said alternating parallel flyback converter; and
a controller, coupled to said output current detector and said output voltage detector, and coupled to a switch of each of the plurality of flyback circuits, for controlling operation of each flyback circuit based on detected output current and output voltage; a portion of the plurality of flyback circuits being set as master branch circuits, and the remaining portion of the plurality of flyback circuits being set as slave branch circuits, wherein said master branch circuits operate continuously under the control of said controller, and said slave branch circuits only operate when a power at the output terminal of said alternating parallel flyback converter is higher than a threshold, and operation of the master branch circuits and the slave branch circuits is alternated periodically under the control of said controller.

2. The alternating parallel flyback converter of claim 1, wherein said each flyback circuit further comprises:
a transformer;
a switching device connected in series to a primary coil of said transformer; and
a diode connected in series to a secondary coil of the transformer.

3. The alternating parallel flyback converter of claim 2, wherein said switching device is a field effect transistor.

4. The alternating parallel flyback converter of claim 1, wherein said controller further comprises:
a detection circuit, its input terminal being coupled to said output current detector and said output voltage detector, for converting the output current and output voltage from analog signals to digital signals;
a processing circuit coupled to said detection circuit, wherein a control signal of each of the plurality of flyback circuits is obtained and transmitted by using zero crossing of the power based on the output current and output voltage in the form of said digital signals; and
a control circuit coupled to said processing circuit, for receiving said control signal and providing an operation signal for switching on or off a switching device in each of the plurality of flyback circuits connected thereto issued based on the received control signal.

5. The alternating parallel flyback converter of claim 1, wherein the periodical alternation between the master branch circuits and the slave branch circuits is controlled by said controller through zero crossing of the power.

6. The alternating parallel flyback converter of claim 1, wherein said alternating parallel flyback converter is a direct current to direct current converter.

7. The alternating parallel flyback converter of claim 6, wherein said direct current to direct current converter further comprises: an input capacitor connected to an input terminal of said converter for storing energy.

8. An alternating parallel flyback converter with alternated master-slave branch circuits, comprising:
at least two flyback circuits connected in parallel;
an output current detector for detecting an output current at an output terminal of said alternating parallel flyback converter;
an output voltage detector for detecting an output voltage at an output terminal of said alternating parallel flyback converter; and
a controller, coupled to said output current detector and said output voltage detector, and coupled to a switch of each of the at least two flyback circuits, for controlling operation of each flyback circuit based on detected output current and output voltage; one or more of the at least two flyback circuits being set as master branch circuits, and the remaining being set as slave branch circuits, wherein said master branch circuits operate continuously under the control of said controller, and said slave branch circuits only operate when a power at the output terminal of said alternating parallel flyback converter is higher than a threshold, and operation of the master branch circuits and the slave branch circuits is alternated periodically under the control of said controller.

9. The alternating parallel flyback converter of claim 8, wherein said each flyback circuit further comprises:
a transformer;
a switching device connected in series to a primary coil of said transformer; and
a diode connected in series to a secondary coil of the transformer.

10. The alternating parallel flyback converter of claim 9, wherein said switching device is a field effect transistor.

11. The alternating parallel flyback converter of claim 8, wherein said controller further comprises:
a detection circuit, its input terminal being coupled to said output current detector and said output voltage detector, for converting the output current and output voltage from analog signals to digital signals;
a processing circuit coupled to said detection circuit, wherein a control signal of each flyback circuit is obtained and transmitted by using zero crossing of the power based on the output current and output voltage in the form of said digital signals; and
a control circuit coupled to said processing circuit, for receiving said control signal and providing an operation signal for switching on or off a switching device in each flyback circuit connected thereto issued based on the received control signal.

12. The alternating parallel flyback converter of claim 8, wherein the periodical alternation between the master branch circuits and the slave branch circuits is controlled by said controller through zero crossing of the power.

13. The alternating parallel flyback converter of claim 8, wherein said alternating parallel flyback converter is a direct current to direct current converter.

14. The alternating parallel flyback converter of claim 13, further comprising an input capacitor connected to an input terminal of said converter for storing energy.
